(19) United States
(12) Patent Application Publication
(10) Pub. No.: US 2026/0072589 A1
(43) Pub. Date: Mar. 12, 2026

(54) STORAGE DEVICE AND OPERATING METHOD THEREOF

(71) Applicant: Samsung Electronics Co., Ltd., Suwon-si (KR)

(72) Inventors: Taehyung KWON, Suwon-si (KR); Jungho YUN, Suwon-si (KR); Young-Sik LEE, Suwon-si (KR); Jeong-Eun KIM, Suwon-si (KR)

(73) Assignee: Samsung Electronics Co., Ltd., Suwon-si (KR)

(21) Appl. No.: 19/319,068

(22) Filed: Sep. 4, 2025

(30) Foreign Application Priority Data
Sep. 9, 2024 (KR) 10-2024-0122482

(51) Int. Cl. G06F 3/06

(52) U.S. Cl. CPC G06F 3/0605; G06F 3/0659; G06F 3/0679

(57) ABSTRACT

A storage device including a memory device that includes a plurality of nonvolatile memory blocks; and a memory controller that controls the memory device. The memory controller performs a first write operation based on a request of a host and a second write operation based on garbage collection on the memory device, based on primary tokens and secondary tokens. The memory controller generates the primary tokens based on a size of a valid page of a victim block from among the plurality of nonvolatile memory blocks, and generates the secondary tokens based on a consumption amount of the primary tokens.

### CROSS-REFERENCE TO RELATED APPLICATIONS

This application claims priority under 35 U.S.C. § 119 to Korean Patent Application No. 10-2024-0122482 filed on Sep. 9, 2024, in the Korean Intellectual Property Office, the disclosure of which is incorporated by reference herein in its entirety.

### BACKGROUND

Some example embodiments of the present disclosure relate to storage devices and operating methods thereof. For example, the present disclosure relates to storage devices capable of uniformly performing a background operation and an operation based on a host request, and operating methods thereof.

The amount of data is increasing as artificial intelligence (AI) and autonomous driving are commercialized. In some example embodiments, a storage capacity of a data center is also continuously increasing, and services of the data center are also evolving. As a semiconductor device-based solid-state drive (SSD) offers high input/output (I/O) performance and low energy consumption compared to a hard disk drive (HDD), the use of solid-state drives is expanding in data center and cloud computing environments where multiple users share resources.

To maintain performance, a storage device may perform various background operations. The storage device may perform a foreground operation based on a host request, in parallel with the execution of the background operation. For example, the storage device may alternately perform the background operation and the foreground operation.

### SUMMARY

Some example embodiments of the present disclosure provide a storage device capable of improving quality of service and an operating method thereof.

Some example embodiments of the present disclosure provide a storage device capable of maintaining and/or improving the quality and/or uniformity of execution of a background operation and a foreground operation, and an operating method thereof.

Some example embodiments provide a storage device including a memory device that includes a plurality of nonvolatile memory blocks; and a memory controller that controls the memory device. The memory controller performs a first write operation based on a request of a host and a second write operation based on garbage collection on the memory device, based on primary tokens and secondary tokens. The memory controller generates the primary tokens based on a size of a valid page of a victim block from among the plurality of nonvolatile memory blocks, and generates the secondary tokens based on a consumption amount of the primary tokens.

Some example embodiments further provide a storage device including a memory device that includes a plurality of nonvolatile memory blocks; and a memory controller that controls the memory device. The memory controller includes a token generation circuit that generates primary tokens and secondary tokens, and an input/output managing circuit that transmits, to the memory device, first internal commands for a first write operation based on a request of a host and second internal commands for performing a second write operation based on garbage collection, based on the secondary tokens. The token generation circuit generates the primary tokens based on a size of a valid page of a victim block from among the plurality of nonvolatile memory blocks, and generates the secondary tokens based on a consumption amount of the primary tokens.

Some example embodiments still further provide an operating method of a storage device. The storage device includes a memory controller and a memory device. The operating includes determining, at the memory controller, to execution garbage collection on the memory device; generating, at the memory controller, primary tokens based on a size of a valid page of a victim block of the memory device on which the garbage collection is performed; generating, at the memory controller, secondary tokens based on a consumption amount of the primary tokens; and performing, at the memory controller, a first write operation based on a request of a host and a second write operation based on the garbage collection, based on the primary tokens and the secondary tokens.

### BRIEF DESCRIPTION OF THE DRAWINGS

The above and other objects and features of the present disclosure will become apparent in view of the following detailed description of some example embodiments with reference to the accompanying drawings.

FIG. 1 is a block diagram describing a storage device according to some example embodiments of the present disclosure.

FIG. 2 is a diagram describing primary tokens and secondary tokens according to some example embodiments of the present disclosure.

FIG. 3 is a diagram illustrating a software architecture of a storage device of FIG. 1.

FIG. 4 is a diagram describing a configuration of a storage device according to some example embodiments of the present disclosure.

FIG. 5 is a diagram illustrating a configuration of a memory controller according to some example embodiments of the present disclosure.

FIG. 6 is a diagram illustrating a configuration of a memory device according to some example embodiments of the present disclosure.

FIG. 7 is a diagram illustrating a configuration of a memory block according to some example embodiments of the present disclosure.

FIG. 8 is a diagram illustrating some of components of a memory controller according to some example embodiments of the present disclosure.

FIG. 9 is a diagram describing a configuration of a garbage collection circuit according to some example embodiments of the present disclosure.

FIG. 10 is a diagram describing an operation based on tokens of an input/output managing circuit according to some example embodiments of the present disclosure.

FIG. 11 is a diagram describing a configuration of a garbage collection circuit according to some example embodiments of the present disclosure.

FIG. 12 is a flowchart describing an operating method of a storage device according to some example embodiments of the present disclosure.

FIG. 13 is a diagram describing an operation of generating primary tokens, in the operating method of FIG. 11.

FIG. 14 is a diagram describing an operation of generating secondary tokens, in the operating method of FIG. 11.

FIG. 15 is a flowchart describing an operating method of a storage device according to some example embodiments of the present disclosure.

FIG. 16 is a diagram describing a comparative example of an operation method in which a storage device may generate a primary token and a secondary token.

FIG. 17 is a diagram describing a change in performance of a first write operation of a storage device according to the comparative example of FIG. 16.

FIGS. 18 and 19 are diagrams describing methods in which a storage device according to some example embodiments of the present disclosure generates a primary token and a secondary token.

FIG. 20 is a diagram describing a change in performance of a first write operation of a storage device according to some example embodiments of the present disclosure.

### DETAILED DESCRIPTION

Below, some example embodiments of the present disclosure will be described in detail and clearly to such an extent that one of ordinary skill in the art may easily carry out the present disclosure.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

The following terms such as, for example, “at least one of A, B, and C” and similar language (e.g., “at least one selected from the group consisting of A, B, and C”) when used in the specification may be construed as A only, B only, C only, or any combination of two or more of A, B, and C, such as, for instance, ABC, AB, BC, and AC.

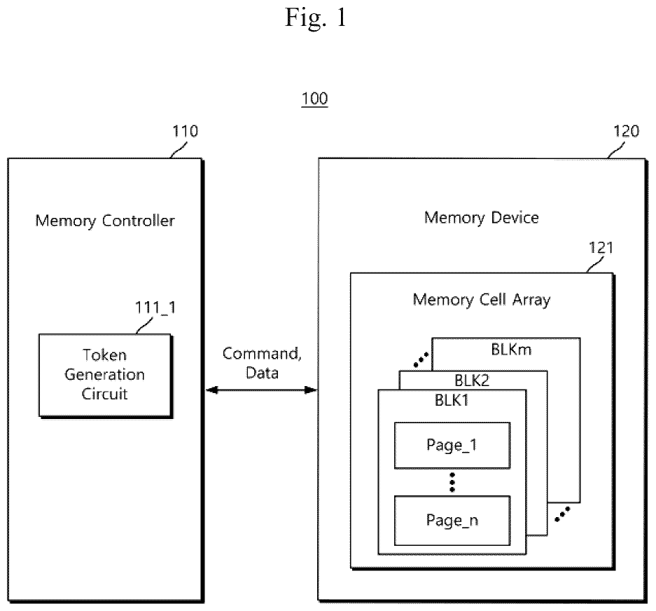

FIG. 1 is a block diagram illustrating a storage device 100 according to some example embodiments of the present disclosure. The storage device 100 according to some example embodiments of the present disclosure will be described with reference to FIG. 1.

According to some example embodiments of the present disclosure, the storage device 100 may include the token generation circuit 111_1. The token generation circuit 111_1 may generate tokens for performing the background operations and the foreground operations of the storage device 100, respectively. The token generation circuit 111_1 may generate primary tokens and secondary tokens. The token generation circuit 111_1 may generate the secondary tokens based on a consumption amount of the primary tokens. This will be described in detail with reference to FIG. 1.

The description will be given in detail with reference to FIG. 1. Referring to FIG. 1, the storage device 100 may include a memory controller 110 and a memory device 120.

The storage device 100 may be an internal memory embedded in an electronic device. For example, the storage device 100 may include a solid state drive (SSD), an embedded universal flash storage (UFS) device, or an embedded multi-media card (eMMC).

Alternatively, the storage device 100 may be an external storage device removable from an electronic device. For example, the storage device 100 may include a UFS memory card, a compact flash (CF) card, a secure digital (SD) card, a micro-SD card, a mini-SD card, an extreme digital (xD) card, or a memory stick.

However, this is provided as an example. According to some example embodiments, the storage device 100 may be referred to as a “personal computer”, a “data server”, “network attached storage” (NAS), an “Internet of Things (IoT) device”, a “portable electronic device”, etc.

The storage device 100 may be electrically connected to a host so as to be used by the host, and the storage device 100 is capable of being accessed through a direct media access (DMA) of any device other than the host.

The storage device 100 may be implemented in a state of being physically separated from the host or may be implemented with the form factor mounted on the same package as the host. For example, the storage device 100 may be implemented based on the E1.S, E1.L, E3.S, E3.L, or PCIe AIC (CEM) form factor. Alternatively, the storage device 100 may be implemented based on the U.2 form factor, the M.2 form factor, or any other PCIe form factor.

The storage device 100 may be coupled such that it is possible to communicate with any other components of the host through a storage interface bus. According to some example embodiments, the storage device 100 may be directly mounted on a physical port which is based on the peripheral component interconnect express (PCIe). The storage interface bus may be, for example, a PCIe bus. The host may exchange data with the storage device 100 through the storage interface bus by using a storage interface protocol. The data may include user data. The storage interface protocol may be, for example, a compute express link (CXL) protocol and/or a non-volatile memory host controller express (NVMe) protocol.

The memory controller 110 may control the memory device 120 to perform a request received from the host. The request of the host may include a request for a write operation, a read operation, and/or an erase operation of user data. The write operation may be referred to as a “record operation, a “store operation”, and/or a “program operation”. In the specification, the expression “the memory controller 110 performs the write operation of data” is used as the same meaning as the memory controller 110 controls the memory device 120 such that data are programmed in the memory device 120. The data may be user data or may be any other desired (and/or alternatively preset) pattern data.

The memory device 120 may include a flash memory of a two-dimensional (2D) structure or a three-dimensional (3D) structure. The flash memory may include different kinds of nonvolatile memories such as a NAND flash memory, a vertical NAND (V-NAND) flash memory, a NOR flash memory, a magnetic RAM (MRAM), a phase-change RAM (PRAM), a ferroelectric random access memory (FRAM), a spin transfer torque random access memory (STT-RAM), and/or a resistive RAM (RRAM).

The memory controller 110 may control the memory device 120 depending on a request of an external device (e.g., a host). For example, to read the user data depending on the request of the host, the memory controller 110 may transmit an address and a command to the memory device 120. The memory controller 110 may exchange data with the memory device 120 depending on the request of the external device such as a host.

The memory device 120 may include a memory cell array 121, and the memory cell array 121 may include a plurality of memory blocks BLK1 to BLKm. In the specification, a memory block may be simply marked by a block. Each of the plurality of blocks BLK1 to BLKm may include a plurality of memory cells. Each of the plurality of memory cells may be a single level cell (SLC) storing 1-bit data or may be a multi-level cell (MLC) storing 2-bit data. Alternatively, each of the plurality of memory cells may be a triple level cell (TLC) storing 3-bit data or may be a quadruple level cell (QLC) storing 4-bit data. In the specification, the size of data stored in a memory cell may not be limited, and a memory cell may store various sizes of bit data.

According to some example embodiments of the present disclosure, the storage device 100 may include the token generation circuit 111_1.

The token generation circuit 111_1 may generate tokens for performing the background operation and the foreground operation of the storage device 100, respectively. In the specification, a token for performing an operation may be expressed as a token allocated to the operation and/or a token used in the operation.

The token may indicate the authority to perform the background operation and the foreground operation. For example, the memory controller 110 may decrease a token one by one whenever the background operation is performed. The memory controller 110 may decrease a token one by one whenever the foreground operation is performed.

In some example embodiments, the memory controller 110 may decrease a token when an operation of a request unit of the host is performed. Alternatively, the memory controller 110 may decrease a token when each of a plurality of internal commands generated based on the request of the host is executed.

A unit of an operation corresponding to the token may vary depending on a token policy of the memory controller 110. In the specification, in some example embodiments the expression that a token is used for a specific operation includes to use a token to one internal command among a plurality of internal commands for the specific operation.

The memory controller 110 may decrease a token one by one whenever the background operation is performed. For example, the memory controller 110 may decrease a token generated for the background operation every operation such as a garbage collection operation, a read reclaim operation, and/or a wear leveling operation. The memory controller 110 may decrease a token one by one whenever the foreground operation is performed. For example, the memory controller 110 may decrease a token whenever the read operation, the write operation, and/or the erase operation according to the request of the host is performed.

In the following some example embodiments, the write operation for garbage collection which the memory controller 110 performs as the background operation and the write operation which the memory controller 110 performs as the foreground operation in response to the host request will be described as an example. However, a method and a circuit for generating the token of the present disclosure are not limited only to the generation of a token for the write operation corresponding to the host request. The method and the circuit for generating the token of the present disclosure may be used to generate a token for various background operations and foreground operations which are not described or disclosed above.

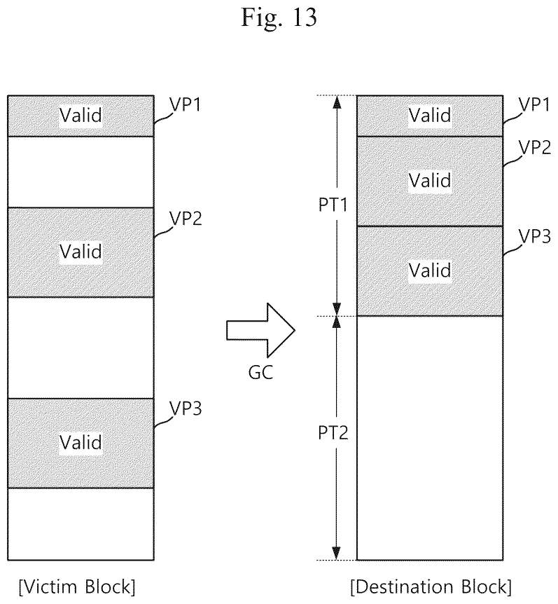

The token generation circuit 111_1 of the memory controller 110 may generate the primary tokens and the secondary tokens. The primary tokens may include primary tokens for the first write operation based on the host request and primary tokens for the second write operation based on garbage collection. Likewise, the secondary tokens may include secondary tokens for the first write operation based on the host request and secondary tokens for the second write operation based on garbage collection. The primary tokens may be generated for each of background operations and foreground operations. For example, the primary tokens for background operations and the primary tokens for foreground operations may be generated. In one embodiment, the primary tokens may be determined based on load balancing between foreground operations and background operations. For example, the primary tokens for background operations and the primary tokens for foreground operations may be based on the amount of workload for each of the foreground operations to be performed and the background operations to be performed. For example, as further described below, the amount of pages to be used by garbage collection within a destination block in FIG. 13, and the amount of residual pages within the destination block, may be determined as the primary tokens for background operations and the primary tokens for foreground operations, respectively. The method of determining the ratio of the primary tokens for background operations and the primary tokens for foreground operations in the present disclosure is not limited to the above description and may be implemented by various other methods. The secondary tokens may be generated within the remaining quantity of the primary tokens. The secondary tokens may be generated for each of background operations and foreground operations. For example, the secondary tokens for background operations may be generated within the remaining quantity of the primary tokens for background operations. The secondary tokens for foreground operations may be generated within the remaining quantity of the primary tokens for foreground operations.

For the execution of an arbitrary operation, the memory controller 110 may individually use the primary token and the secondary token one by one. For example, for the first write operation based on the host request, the memory controller 110 may individually use the primary token and the secondary token allocated to the first write operation one by one. Likewise, for the second write operation based on garbage collection, the memory controller 110 may individually use one primary token and one secondary token allocated to the second write operation.

The memory controller 110 may determine a victim block targeted for garbage collection. The victim block may mean a block whose data are deleted (or erased) to secure a storage space when the storage device 100 perform garbage collection. The storage device 100 may determine a victim block by using various garbage collection methods. For example, the memory controller 110 may determine, as a victim block, a block whose valid page count is the smallest, and the method of determining a victim block is not limited thereto.

In some example embodiments, the token generation circuit 111_1 may generate the primary tokens based on the size of a valid page of a victim block. For example, the token generation circuit 111_1 may generate primary tokens for the first write operation and primary tokens for the second write operation to be proportional to the number of residual pages other than valid pages of the victim block in a destination block and the number of valid pages of the victim block, respectively. It is described in detail below with reference to FIG. 13.

In some example embodiments, the token generation circuit 111_1 may generate secondary tokens based on the number of primary tokens. For example, the token generation circuit 111_1 may generate secondary tokens over plural times so as to be classified into a plurality of groups. The total number of secondary tokens classified into the plurality of groups may be equal to the number of primary tokens.

In some example embodiments, the token generation circuit 111_1 may generate secondary tokens based on a consumption amount of primary tokens. For example, when the token generation circuit 111_1 generates secondary tokens classified into a plurality of groups, the token generation circuit 111_1 may generate secondary tokens of a specific group based on a consumption amount of primary tokens used before the secondary tokens of the specific group are generated.

As the token generation circuit 111_1 applies the consumption amount of primary tokens to generate secondary tokens, the storage device 100 may be limited and/or prevented from performing only one of the first write operation or the second write operation. For example, the operation of the storage device 100 may be limited and/or prevented from being focused on (or biased).

For example, a storage device of a comparative example may determine a first ratio being a ratio of primary tokens for the first write operation and the second write operation. When such a storage device of the comparative example determines a second ratio, which is a ratio of secondary tokens for the first write operation and the second write operation included in each group of secondary tokens classified into a plurality of groups, to be identical to the first ratio, the number of secondary tokens according to the second ratio of each group may not be an integer. Accordingly, when the second ratio is applied with a ratio using an integer close to the first ratio, secondary tokens for an arbitrary one among the first write operation or the second write operation may not be generated in a specific group. For example, secondary tokens for an arbitrary one of the first write operation or the second write operation may not be generated in the last group. Accordingly, based on the secondary tokens of the last group, the storage device of the comparative example may perform only an arbitrary one of the first write operation or the second write operation, thereby causing uneven (or irregular) quality of execution of the storage device.

In contrast, the storage device 100 according to some example embodiments of the present disclosure may apply a consumption amount of primary tokens to generate secondary tokens, and in some example embodiments, even though secondary tokens are classified into a plurality of groups, the storage device 100 may limit and/or prevent only an arbitrary one of the first write operation or the second write operation from being performed. For example, all the groups may include secondary tokens corresponding to the first write operation and a secondary token corresponding to the second write operation. Accordingly, the quality of execution of the storage device 100 may be uniform.

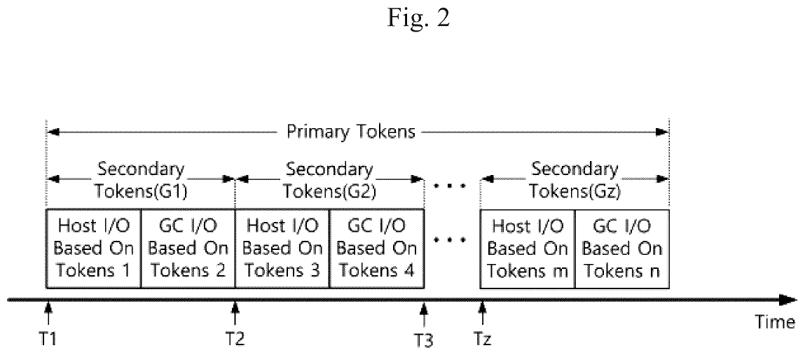

FIG. 2 is a diagram describing primary tokens and secondary tokens according to some example embodiments of the present disclosure. Primary tokens and secondary tokens to be described with reference to FIG. 2 may be generated by the storage device 100 of FIG. 1. For example, the token generation circuit 111_1 of FIG. 1 may generate a primary token and a secondary token. Based on primary tokens and secondary tokens, the storage device 100 may perform the first write operation based on a host request and the second write operation based on garbage collection.

The storage device 100 may generate primary tokens and may then generate secondary tokens.

For example, the token generation circuit 111_1 may generate primary tokens for the first write operation and primary tokens for the second write operation to be proportional to the number of residual pages other than valid pages in the victim block and the number of valid pages in the victim block, respectively.

In the specification, in association with primary tokens, a ratio of primary tokens for the first write operation and primary tokens for the second write operation may be referred to as a “primary token ratio”. As in the above description, in association with secondary tokens of each group, a ratio of secondary tokens for the first write operation and secondary tokens for the second write operation may be referred to as a “secondary token ratio”.

The storage device 100 may generate secondary tokens classified into a plurality of groups over plural times. The number of primary tokens allocated to the first write operation may be equal to the total number of secondary tokens of all the groups allocated to the first write operation. The number of primary tokens allocated to the second write operation may be equal to the total number of secondary tokens of all the groups allocated to the second write operation.

Accordingly, a first period by which primary tokens are generated may be longer than a second period by which secondary tokens are generated. For example, the storage device 100 may generate primary tokens whenever a victim block targeted for garbage collection is selected and may generate secondary tokens over plural times based on the primary tokens.

For example, referring to FIG. 2, the storage device 100 may generate secondary tokens over “z” times (z being a natural number). All the secondary tokens may be divided into “z” groups. The storage device 100 may generate secondary tokens of a first group G1 at T1, may generate secondary tokens of a second group G2 at T2, and may selectively generate secondary tokens of the last group Gz among the secondary tokens of the plurality of groups. The number of secondary tokens may be differently determined for each group. For example, the numbers of secondary tokens of some of the plurality of groups may be equal, and the numbers of secondary tokens of the others thereof may be different from each other. The number of secondary tokens of one group may be different from the number of secondary tokens of another group.

Referring to FIG. 2, the storage device 100 may perform the first write operation and the second write operation based on the secondary tokens of the first group G1, respectively. When all the secondary tokens of the first group G1 are consumed (or used) (alternatively, when a residual amount of the secondary tokens of the first group G1 reaches a desired (and/or alternatively preset) level), the storage device 100 may generate the secondary tokens of the second group G2 at T2 and may perform the first write operation and the second write operation based on the secondary tokens of the second group G2. The storage device 100 may generate secondary tokens until all the primary tokens are consumed and may perform the first write operation and the second write operation based on the secondary tokens.

When the storage device 100 uses secondary tokens, the storage device 100 may decrease the primary tokens as much as the same amount. For example, for the first write operation, the storage device 100 simultaneously uses tokens (hereinafter referred to as “(1-1)-th tokens” allocated to the first write operation from among the primary tokens and tokens (hereinafter referred to as “(2-1)-th tokens”) allocated to the first write operation from among the secondary tokens. Also, for the second write operation, the storage device 100 simultaneously uses tokens (hereinafter referred to as “(1-2)-th tokens” allocated to the second write operation from among the primary tokens and tokens (hereinafter referred to as “(2-2)-th tokens”) allocated to the second write operation from among the secondary tokens.

When the storage device 100 generates secondary tokens of each group, the storage device 100 may generate secondary tokens based on a consumption amount of the primary tokens. For example, when secondary tokens of the n-th group (n being a natural number of 2 or more) are generated, a consumption amount of the primary tokens is equal to the total number of secondary tokens of previous groups (e.g., the first to (n-1)-th groups). For example, the consumption amount of the primary tokens is equal to the accumulated consumption amount of secondary tokens of previous groups (e.g., the first to (n-1)-th groups).

In some example embodiments, the storage device 100 may fix the number of secondary tokens allocated to the first write operation for each group or the number of secondary tokens allocated to the second write operation for each group to a desired (and/or alternatively preset) magnitude or number. For example, the storage device 100 may fix an arbitrary one of the number of (2-1)-th tokens and the number of (2-2)-th tokens for each group.

For example, the storage device 100 may fix the number of secondary tokens (e.g., (2-1)-th tokens) allocated to the first write operation for each group. The fixed value may be referred to as a “scaling value”.

For example, the storage device 100 may determine the numbers of (2-2)-th tokens of the first to z-th groups based on a consumption amount of primary tokens, with the numbers of (2-1)-th tokens of the first to z-th groups fixed to the scaling value. Alternatively, the storage device 100 may determine the numbers of (2-1)-th tokens of the first to z-th groups based on a consumption amount of primary tokens, with the numbers of (2-2)-th tokens of the first to z-th groups fixed to the scaling value.

In some example embodiments, based on a ratio of a residual amount of primary tokens allocated to the first write operation and a residual amount of primary tokens allocated to the second write operation, the storage device 100 may determine the secondary token ratio of secondary tokens (e.g., (2-1)-th tokens) allocated to the first write operation and secondary tokens (e.g., (2-2)-th tokens) allocated to the second write operation. The residual amount of primary tokens allocated to the first write operation may be obtained by subtracting the number of primary tokens previously consumed in the first write operation from the number of primary tokens allocated to the first write operation. The residual amount of primary tokens allocated to the second write operation may be obtained by subtracting the number of primary tokens previously consumed in the second write operation from the number of primary tokens allocated to the second write operation.

For example, the storage device 100 may determine the number of secondary tokens such that a ratio (hereinafter referred to as a “primary residual token ratio”) of a residual amount of primary tokens allocated to the first write operation and a residual amount of primary tokens allocated to the second write operation is equal to or substantially equal to the secondary token ratio of each group.

For example, the storage device 100 may generate secondary tokens of the n-th group based on Equation 1 below.

$$( The number of primary tokens allocated to the first write operation - the number of primary tokens previously consumed in the first write operation ) : ( the number of primary tokens allocated to the second write operation - the number of primary tokens previously consumed in the second write operation ) = ( the number of secondary tokens allocated to the first write operation of the n - th group ) : ( the number of secondary tokens allocated to the second write operation of the n - th group ) \qquad 〈 Equation 1 〉$$

In some example embodiments, one of the number of secondary tokens allocated to the first write operation of the n-th group and the number of secondary tokens allocated to the second write operation of the n-th group may be fixed to the scaling value.

For example, the storage device 100 may calculate (e.g., determine) the number of (2-1)-th tokens of each group, based on the number of (2-2)-th tokens fixed to the scaling value and the primary residual token ratio. Alternatively, the storage device 100 may calculate (e.g., determine) the number of (2-2)-th tokens of each group, based on the number of (2-1)-th tokens fixed to the scaling value and the primary residual token ratio.

The method in which the storage device 100 generates secondary tokens based on Equation 1 above is described with reference to FIG. 2.

In some example embodiments, because previously consumed primary tokens do not exist (e.g., because the primary token ratio is identical to the primary residual token ratio) when the storage device 100 generates the secondary tokens of the first group G1 at T1, the storage device 100 may generate the secondary tokens of the first group G1, based on the primary token ratio being the ratio of (1-1)-th tokens allocated to the first write operation and (1-2)-th tokens allocated to the second write operation among the primary tokens. For example, the storage device 100 may calculate the number of (2-1)-th tokens of the first group G1 based on Equation 1 above, with the number of (2-2)-th tokens of the first group G1 fixed to the scaling value.

When the storage device 100 generates the secondary tokens of the second group G2 at T2, the storage device 100 may generate the secondary tokens of the second group G2, based on the primary residual token ratio (e.g., (the number of (1-1)-th tokens-the number of (2-1)-th tokens of the first group): (the number of (1-2)-th tokens-the number of (2-2)-th tokens of the first group). For example, the storage device 100 may calculate the number of (2-1)-th tokens of the second group G2 based on Equation 1 above, with the number of (2-2)-th tokens of the second group G2 fixed to the scaling value.

At T3 to Tz-1, the storage device 100 may generate secondary tokens of each group based on the same method as generating the secondary tokens at T2.

At Tz, the storage device 100 may generate secondary tokens of the last group Gz to be identical to the number of residual primary tokens. For example, when the number of residual (1-1)-th tokens is “i” (i being an integer of 0 or more) and the number of residual (1-2)-th tokens is “j” (j being an integer of 0 or more), the number of (2-1)-th tokens of the last group Gz may be “i, and the number of (2-2)-th tokens of the last group Gz may be “j”.

Accordingly, all the groups constituting the secondary tokens may include secondary tokens corresponding to the first write operation and secondary tokens corresponding to the second write operation. Accordingly, the quality of execution of the storage device 100 may be uniform.

In some example embodiments, when the number of secondary tokens of each group which the storage device 100 determines based on Equation 1 above and the scaling value is a decimal (e.g., the number of secondary tokens is expressed as also including a non-integer portion), the storage device 100 may round up the number of secondary tokens. For example, when the number of (2-2)-th tokens is fixed to the scaling value, the number of (2-1)-th tokens of an arbitrary group may be calculated as a number including a decimal place. In some example embodiments, the storage device 100 may determine the number of (2-1)-th tokens as an integer obtained by rounding up a decimal place (e.g., rounding up the non-integer portion).

In some example embodiments, when the number of secondary tokens of each group which the storage device 100 determines based on Equation 1 above and the scaling value is a decimal, the storage device 100 may stochastically determine the number of secondary tokens. For example, when the number of (2-2)-th tokens is fixed to the scaling value, the number of (2-1)-th tokens of an arbitrary group may be calculated (e.g., determined) as a number including a decimal place. In some example embodiments, the storage device 100 may determine the number of (2-1)-th tokens based on the probability of a number of a decimal place.

For example, the number of (2-2)-th tokens may be in advance set to 32 being the scaling value, and the secondary token ratio of the n-th group based on Equation 1 above may be 12.665:32. In some example embodiments, the storage device 100 may determine the number of (2-1)-th tokens as 13 with the probability of 0.665. For another example, the number of (2-2)-th tokens may be in advance set to 32 being the scaling value, and the secondary token ratio of the n-th group based on Equation 1 above may be 12.3:32. In some example embodiments, the storage device 100 may determine the number of (2-1)-th tokens as 13 with the probability of 0.3. In some example embodiments, the token generation circuit 111_1 of the storage device 100 may include a selection circuit which is based on the probability. For example, the storage device 100 may include a selection circuit based on a random number generator. The random number generator may be based on a Linear Feedback Shift Register (LFSR). The storage device 100 generates a random number based on a probability p (e.g., the probability corresponding to the decimal place of the (2-1)-th tokens of an arbitrary group), and when the generated random number is less than the probability p, the storage device 100 may determine the number of (2-1)-th tokens to be 13, but the present disclosure is not limited thereto.

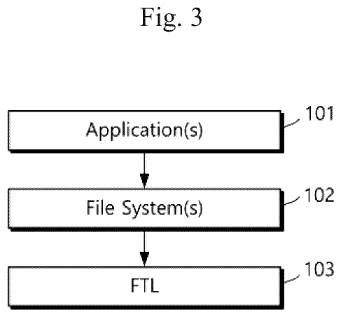

FIG. 3 is a diagram illustrating a software architecture of a storage device of FIG. 1.

Referring to FIGS. 1 and 2, the software architecture of the storage device 100 may include an application 101, a file system 102, and a flash translation layer (FTL) 103. In some example embodiments, the application 101 and the file system 102 may be included in an external device (e.g., a host) or may be driven by the external device.

The application 101 may include various programs which are driven on an operating system (OS) of the external device. For example, the application 101 may include various programs such as a text editor, an image player, and a web browser.

The file system 102 may perform a role of organizing files or data which are used by the application 101. For example, the file system 102 may provide an address of a file or data. In some example embodiments, the address may be a logical address which is organized or managed by the external device.

The flash translation layer 103 provides an interface between the external device and the memory device 120 such that the memory device 120 is efficiently used. For example, the flash translation layer 103 may perform an operation of translating a logical address provided from the external device into a physical address usable in the memory device 120. For example, the flash translation layer 103 may manage the address translation operation through a mapping table.

In some example embodiments, the above operations based on garbage collection and a host request may be performed based on the flash translation layer 103. For example, to perform the first write operation based on the host request and the second write operation based on the garbage collection, the memory controller 110 of FIG. 1 may control the memory device 120 based on the flash translation layer 103.

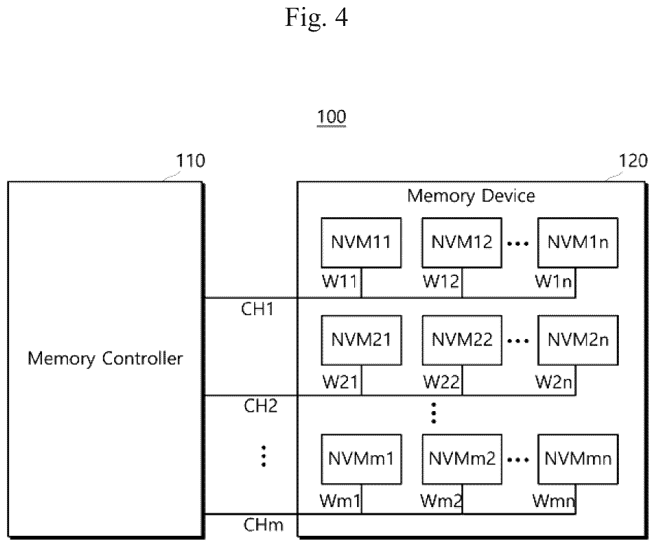

FIG. 4 is a diagram illustrating a configuration according to some example embodiments of a memory device according to some example embodiments of the present disclosure. The storage device 100 of FIG. 4 may correspond to the storage device 100 of FIG. 1.

The memory controller 110 may perform an I/O for a plurality of memory devices NVM11 to NVMmn through a plurality of channels CH1 to CHm. The memory device 120 and the memory controller 110 may be connected through the plurality of channels CH1 to CHm. In some example embodiments, the memory controller 110 may include a plurality of controller modules respectively corresponding to the plurality of channels CH1 to CHm.

The memory controller 110 may control a memory device (e.g., one of NVM11 to NVMmn) connected to one of the plurality of channels CH1 to CHm through a way.

The memory controller 110 may exchange signals with the memory device 120 through the plurality of channels CH1 to CHm.

The memory device 120 may include a plurality of nonvolatile memory devices NVM11 to NVMmn. Each of the nonvolatile memory devices NVM11 to NVMmn may be a nonvolatile memory package. In some example embodiments, each of the nonvolatile memory devices NVM11 to NVMmn may include a plurality of dies, but the present disclosure is not limited thereto.

In some example embodiments, the storage device 100 according to some example embodiments of the present disclosure may generate a primary token and a secondary token for each of the plurality of channels CH1 to CHm. In some example embodiments, the storage device 100 may perform the first write operation and the second write operation based on the primary token and the secondary token generated for each of the channels CH1 to CHm.

Alternatively, the storage device 100 according to some example embodiments of the present disclosure may generate a primary token and a secondary token for all of the plurality of channels CH1 to CHm. In some example embodiments, the storage device 100 may perform the first write operation and the second write operation based on the primary token and the secondary token generated for all the channels CH1 to CHm.

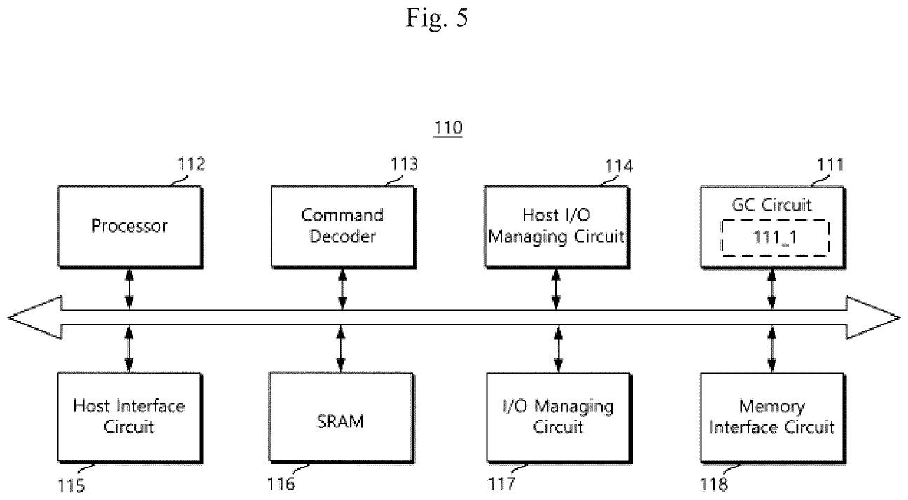

FIG. 5 is a diagram illustrating a configuration of a memory controller according to some example embodiments of the present disclosure. The memory controller 110 to be described with reference to FIG. 5 may correspond to the memory controller 110 of the storage device 100 of FIG. 1.

In some example embodiments, a command decoder, a host input/output manager, garbage collection, and/or an input/output manager may be implemented as an independent circuit and/or a portion of firmware. FIG. 5 will be described under the assumption that the host input/output manager, the garbage collection, and the input/output manager are respectively implemented with a host input/output (I/O) managing circuit 114, a garbage collection circuit 111, and an input/output (I/O) managing circuit 117 as an independent circuit, but the present disclosure is not limited thereto.

The memory controller 110 may include the garbage collection circuit 111, a processor 112, a command decoder 113, the host input/output managing circuit 114, a host interface circuit 115, an SRAM 116, the input/output managing circuit 117, and a memory interface circuit 118. Although not illustrated in FIG. 5, the memory controller 110 may include a flash translation layer (FTL), a packet manager, an error correction code (ECC) circuit and/or a working memory device.

The processor 112 may be implemented with a circuit, logic, or a code or a combination thereof. The processor 112 overall controls operations of the storage device 100 including the memory controller 110. When the storage device 100 is driven, the processor 112 may load the firmware stored in a read only memory (ROM) to the working memory device and may perform all the operations of the memory controller 110. The processor 112 may load the flash translation layer to the working memory device; based on an address translation result of the flash translation layer, the processor 112 may program data in the memory device 120 and/or may read data from the memory device 120.

The memory controller 110 may communicate with the host through the host interface circuit 115. The host interface circuit 115 may be implemented with various interface manners such as advanced technology attachment (ATA), serial ATA (SATA), external SATA (e-SATA), small computer small interface (SCSI), serial attached SCSI (SAS), peripheral component interconnection (PCI), PCI express (PCIe), IEEE 1394, universal serial bus (USB), NVMe, and CXL.

The command decoder 113 may decode a command parsed from the command, based on the protocol of the interface negotiated on the host. The packet manager may parse the command from the packet received from the host, based on the protocol of the interface negotiated on the host. For example, the command decoder 113 may decode an opcode of the command which is based on a specific protocol and may identify a program command, an erase command, a read command, and/or a secure erase command. The processor 112 may perform the request of the host depending on the decoded commands. The command decoder 113 may be implemented as an independent circuit and/or a portion of firmware.

The flash translation layer may perform various functions such as address mapping, wear-leveling, and garbage collection.

The address mapping operation refers to an operation of translating a logical address received from the host into a physical address to be actually used to program data in the memory device 120. For example, a logical block address (LBA) of user data which are requested by the host to be programmed may be translated into a physical address of the memory device 120 of FIG. 1 by using the flash translation layer. In some example embodiments, the physical address may be a physical page number (PPN). In some example embodiments, a mapping table which the flash translation layer manages may store a mapping relationship between a logical page number (LPN) and a physical page number. In some example embodiments, each of logical page numbers LPN may correspond to a plurality of logical block addresses LBA.

The wear-leveling which is a technology for allowing blocks of the memory device 120 of FIG. 1 to be used uniformly such that excessive degradation of a specific block is limited and/or prevented may be implemented, for example, through a firmware technology for balancing erase counts of physical blocks.

The working memory device (not illustrated) may include a register for storing internal variables of the memory controller 110 and/or a buffer memory for performing an operation of the storage device 100. In some example embodiments, the working memory device which operates as a buffer memory may temporarily store data to be recorded at the memory device 120 of FIG. 1 or data read from the memory device 120 of FIG. 1. The working memory device may be implemented with a volatile memory device. According to some example embodiments, the working memory device may be disposed inside and/or outside the memory controller 110. Alternatively, when the host buffer memory is provided by the host, the working memory device may not operate as a buffer memory.

The ECC circuit may generate parity information by performing ECC encoding for data to be programmed in the memory device 120 of FIG. 1 and may add the parity information to the data. Also, the ECC circuit may detect an error bit from the data read from the memory device 120. For example, the memory controller 110 may detect an error bit by performing ECC decoding for the read data. In some example embodiments, the memory device 120 of FIG. 1 may include an on-die ECC circuit. In some example embodiments, the ECC circuit may be implemented as an independent circuit and/or a portion of firmware.

The garbage collection circuit 111 of the memory controller 110 according to some example embodiments of the present disclosure may include the token generation circuit 111_1.

The garbage collection circuit 111 may copy valid data of a victim block to a new block and may then erase the victim block being an existing block. The new volume may be referred to as a “destination block”. The valid data may be copied in units of page.

The token generation circuit 111_1 may generate primary tokens and secondary tokens. The primary tokens may include primary tokens for the first write operation based on the host request and primary tokens for the second write operation based on garbage collection. Likewise, the secondary tokens may include secondary tokens for the first write operation based on the host request and secondary tokens for the second write operation based on garbage collection.

The host input/output managing circuit 114 may generate a plurality of first internal commands for performing a write operation according to a host request. For example, the first internal commands may be internal commands for performing the first write operation described with reference to FIGS. 1 to 4.

In some example embodiments, the garbage collection circuit 111 may read data from a valid page of a victim block which the processor 112 determines. The garbage collection circuit 111 may generate a plurality of second internal commands for writing the read data in a destination block. For example, the second internal commands may be internal commands for performing the second write operation described with reference to FIGS. 2 to 4.

The input/output managing circuit 117 may transmit the first internal commands and the second internal commands to the memory interface circuit 118 based on the primary token and the secondary token which the token generation circuit 111_1 generates.

In some example embodiments, the input/output managing circuit 117 may use a token every internal command. For example, the input/output managing circuit 117 may use (1-1)-th tokens and (2-1)-th tokens whenever the first internal command is executed and/or transmitted. The input/output managing circuit 117 may use (1-2)-th tokens and (2-2)-th tokens whenever the second internal command is executed and/or transmitted.

In some example embodiments, the input/output managing circuit 117 may use a token every desired (and/or alternatively preset) size of write data. For example, the input/output managing circuit 117 may use (1-1)-th tokens and (2-1)-th tokens whenever the size of data transmitted to the memory device 120 based on the execution of the first internal commands reach a desired (and/or alternatively preset) reference. The input/output managing circuit 117 may use (1-2)-th tokens and (2-2)-th tokens whenever the size of data requested to be written in the destination block based on the execution of the second internal commands reach a desired (and/or alternatively preset) reference.

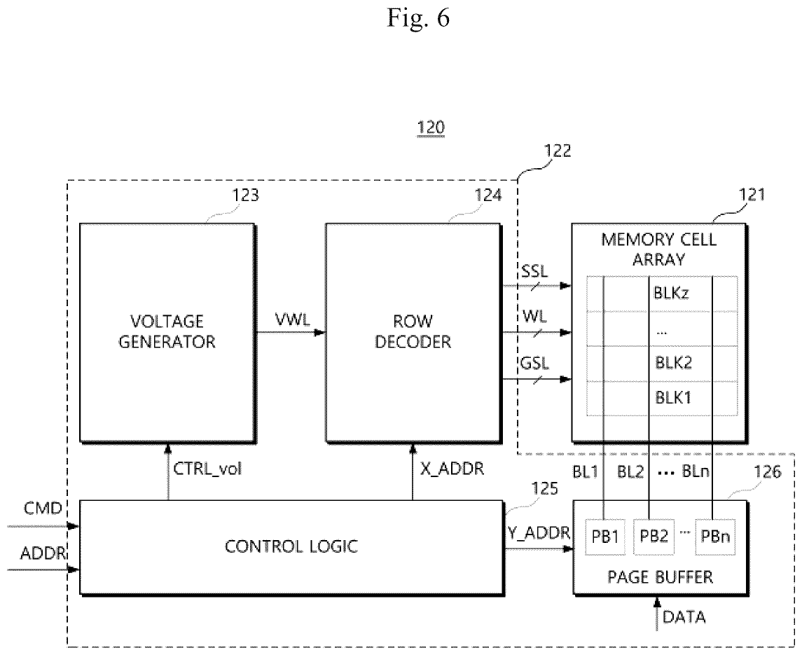

FIG. 6 is a diagram illustrating a configuration according to some example embodiments of a memory device according to some example embodiments of the present disclosure. The memory device 120 to be described with reference to FIG. 6 may correspond to the memory device 120 of FIG. 1.

Referring to FIG. 6, the memory device 120 may include the memory cell array 121, a voltage generator and row decoder 122, control logic 125, and a page buffer block 126. The voltage generator and row decoder 122 may include a voltage generator 123 and a row decoder 124.

The control logic 125 may overall control various kinds of operations of the memory device 120. The control logic 125 may output various kinds of control signals in response to a command CMD and/or a physical address ADDR received from the memory interface circuit 118 of FIG. 5. For example, the control signals may include a voltage control signal CTRL_vol, a row address X_ADDR, and a column address Y_ADDR.

The command CMD according to some example embodiments of the present disclosure may be the internal command described with reference to FIG. 5. For example, the command CMD may be the first internal command and/or the second internal command described with reference to FIG. 5.

The memory cell array 121 may include a plurality of memory blocks BLK1 to BLKz (z being a positive integer), and each of the plurality of memory blocks BLK1 to BLKz may include a plurality of memory cells. The memory blocks BLK1 to BLKz may be connected to the page buffer block 126 through bit lines BL1 to BLn and may be connected to the row decoder 124 through word lines WL, string select lines SSL, and ground select lines GSL.

The page buffer block 126 may include a plurality of page buffers PB1 to PBn (n being an integer of 3 or more), and the plurality of page buffers PB1 to PBn may be connected to memory cells included in each of the plurality of memory blocks BLK1 to BLKz through the plurality of bit lines BL1 to BLn. The page buffer block 126 may select at least one of the bit line BL1 to BLn in response to the column address Y_ADDR. The page buffer block 126 may operate as a write driver or a sense amplifier depending on an operation mode. For example, in the program operation, the page buffer block 126 may apply a bit line voltage corresponding to data “DATA” to be programmed to the selected bit line. In the read operation, the page buffer block 126 may sense a current or a voltage of the selected bit line to read data stored in a memory cell. The plurality of page buffers PB1 to PBn of the page buffer block 126 may sense data stored in memory cells through the plurality of bit lines BL1 to BLn and may temporarily store the sensed data as sensing data.

The voltage generator 123 may generate various kinds of voltages VWL for performing the program operation, read operation, and the erase operation, etc. based on the voltage control signal CTRL_vol.

In response to the row address X_ADDR, the row decoder 124 may select one of the plurality of word lines WL and may select one of the plurality of string select lines SSL.

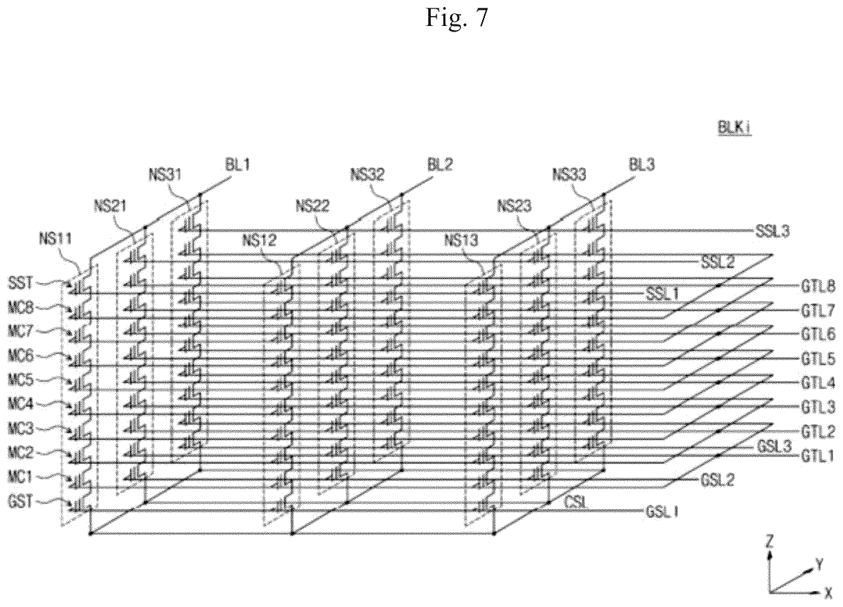

FIG. 7 is a diagram illustrating a configuration according to some example embodiments of a memory block according to some example embodiments of the present disclosure. A memory block BLKi of FIG. 7 may be one of memory blocks included in the memory cell array 121 of the memory device 120 of FIG. 1.

When the memory device 120 of the storage device 100 of FIG. 1 is implemented with a flash memory of a 3D V-NAND type, each of a plurality of memory blocks constituting the memory device 120 may be expressed by an equivalent circuit illustrated in FIG. 7.

The memory block BLKi illustrated in FIG. 7 indicates a three-dimensional memory block formed on a substrate in a three-dimensional structure. For example, a plurality of memory NAND strings included in the memory block BLKi may be formed in a direction perpendicular to the substrate.

Referring to FIG. 7, the memory block BLKi may include a plurality of memory NAND strings NS11 to NS33 connected between bit line BL1, BL2, and BL3 and a common source line CSL. Each of the plurality of memory NAND strings NS11 to NS33 may include a string selection transistor SST, a plurality of memory cells MC1, MC2, . . . MC8, and a ground selection transistor GST. Some example embodiments in which each of the plurality of memory NAND strings NS11 to NS33 includes eight memory cells MC1, MC2, . . . MC8 is illustrated in FIG. 7, but some example embodiments of the present disclosure are not limited thereto and the number of memory cells in a string may be different than 8.

The string selection transistor SST may be connected to a corresponding one of string select lines SSL1, SSL2, and SSL3. The plurality of memory cells MC1, MC2, . . . MC8 may be respectively connected to gate lines GTL1, GTL2, . . . GTL8. The gate lines GTL1, GTL2, . . . GTL8 may correspond to word lines.

In some example embodiments, some of the gate lines GTL1, GTL2, . . . GTL8 may correspond to a dummy word line(s). The ground selection transistor GST may be connected to a corresponding one of ground select lines GSL1, GSL2, and GSL3. The string selection transistor SST may be connected to a corresponding bit line among the bit lines BL1, BL2, and BL3, and the ground selection transistor GST may be connected to the common source line CSL.

Word lines (e.g., WL1) at the same height may be connected in common, and the ground select lines GSL1, GSL2, and GSL3 and the string select lines SSL1, SSL2, and SSL3 may be separated from each other. An example in which the memory block BLKi is connected to eight gate lines GTL1, GTL2, . . . GTL8 and three bit lines BL1, BL2, and BL3 is illustrated in FIG. 7, but some example embodiments of the present disclosure is not limited thereto.

The bit density of the memory block BLKi may vary depending on the number of bits which each of the memory cells included in the memory block BLKi stores.

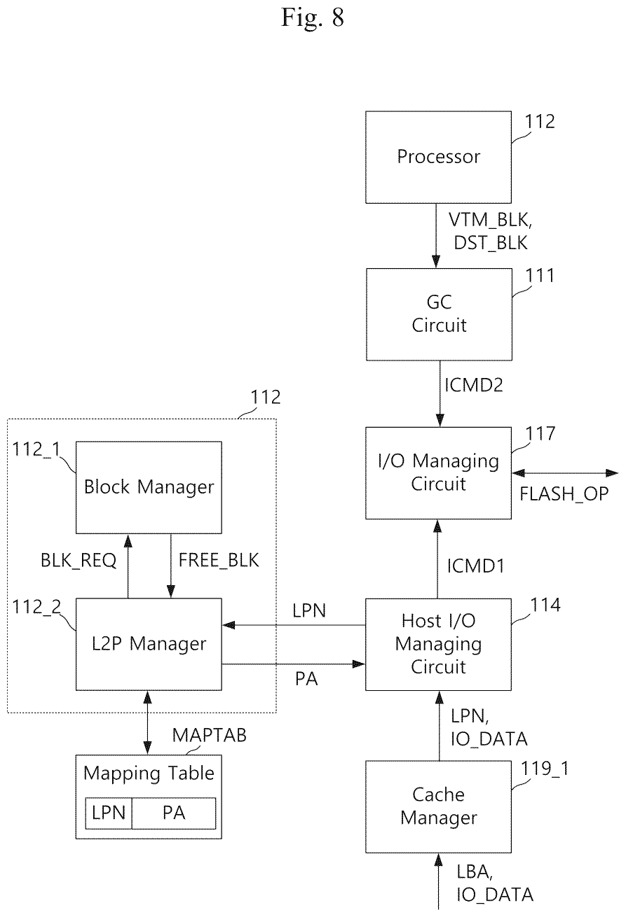

FIG. 8 is a diagram illustrating some of components of a memory controller according to some example embodiments of the present disclosure. The garbage collection circuit 111, the processor 112, the host input/output managing circuit 114, and the input/output managing circuit 117 of FIG. 8 may respectively correspond to the garbage collection circuit 111, the processor 112, the host input/output managing circuit 114, and the input/output managing circuit 117 of FIG. 5. FIG. 8 will be described under the assumption that the garbage collection circuit 111, the host input/output managing circuit 114, and the input/output managing circuit 117 are implemented with a hardware logic circuit, but the garbage collection circuit 111, the host input/output managing circuit 114, and the input/output managing circuit 117 may be implemented by firmware performing the same functions. For the sake of convenience, the processor 112 is also shown in FIG. 8 as a block indicated by dotted line that is connected to host input/output managing circuit 114 and that includes block manager 112_1 and L2P manager 112_2.

Functions and operations of the components of FIG. 8 may be accomplished by functions and operations of components different from the components of FIG. 8 depending on various implementations of the present disclosure. Accordingly, the components of FIG. 8 and messages and/or pieces of data which are transmitted between the components may be implemented by a method different from that of FIG. 8.

A cache manager 119_1 may perform an operation according to a host request. In some example embodiments, the cache manager 119_1 may be provided with a logical block address LBA and/or input/output data IO_DATA. In some example embodiments, when there is performed the read operation according to the host request, the cache manager 119_1 may not be provided with the input/output data IO_DATA.

In some example embodiments, the cache manager 119_1 may convert the logical block address LBA to a logical page number LPN. The cache manager 119_1 may transmit the logical page number LPN and/or the input/output data IO_DATA to the host input/output managing circuit 114.

In some example embodiments, the cache manager 119_1 may process a data hazard. For example, when a plurality of inputs/outputs for the same logical page number LPN are received at different times, the cache manager 119_1 may control the execution of the plurality of inputs/outputs.

The host input/output managing circuit 114 may include an input managing circuit and a logical output managing circuit. The host input/output managing circuit 114 may transmit the logical page number LPN to an L2P manager 112_2 and may receive a physical address PA corresponding to the logical page number LPN. For example, the physical address PA may be a physical page number PPN.

The L2P manager 112_2 may search a mapping table MAPTAB for the physical address PA corresponding to the logical page number LPN. The L2P manager 112_2 may update the mapping table MAPTAB based on the execution of garbage collection and/or the write operation of data. The mapping table MAPTAB may store a mapping relationship between logical addresses and physical addresses. For example, the mapping table MAPTAB may store a correspondence relationship between the logical page number LPN and the physical address PA.

In some example embodiments, when there is no free block FREE_BLK in which data will be written, the L2P manager 112_2 may provide a free block request BLK_REQ to a block manager 112_1 and may be provided with the free block FREE_BLK from the block manager 112_1.

In some example embodiments, the host input/output managing circuit 114 may temporarily store information about the plurality of inputs/outputs in a buffer memory. In some example embodiments, when the size of the plurality of inputs/outputs whose information is temporarily stored in the buffer memory satisfies a desired (and/or alternatively preset) size or the number of inputs/outputs whose information is temporarily stored in the buffer memory satisfies a desired (and/or alternatively preset) value, based on the host request, the host input/output managing circuit 114 may request the input/output managing circuit 117 to perform the plurality of inputs/outputs. For example, the host input/output managing circuit 114 may temporarily store pieces of data and the internal command for the first write operation described with reference to FIGS. 1 to 7 in the buffer memory, may convert the internal command into a specific format ICMD1, and may request the input/output managing circuit 117 to perform the write operation according to the host request.

The processor 112 may transmit an address VTM_BLK of a victim block and an address DST_BLK of a destination block to the garbage collection circuit 111 according to some example embodiments of the present disclosure and may direct the execution of garbage collection. Each of the address VTM_BLK of the victim block and the address DST_BLK of the destination block may be a block number.

The garbage collection circuit 111 according to some example embodiments of the present disclosure may generate primary tokens and secondary tokens as described with reference to FIGS. 1 and 2.

The garbage collection circuit 111 may temporarily store pieces of data and the internal command for the second write operation described with reference to FIGS. 1 to 7 in the buffer memory, may convert the internal command into a specific format ICMD2, and may request the input/output managing circuit 117 to perform the write operation according to the execution of garbage collection.

The input/output managing circuit 117 may partially perform parallel processing for at least one input/output. The input/output managing circuit 117 may convert input data in a form FLASH_OP appropriate for the write operation of the memory device 120 of FIG. 1 so as to be written in the memory device 120 or may read data from the memory device 120.

The input/output managing circuit 117 may perform an input/output according to the host request and an input/output according to garbage collection, based on a primary token and/or a secondary token.

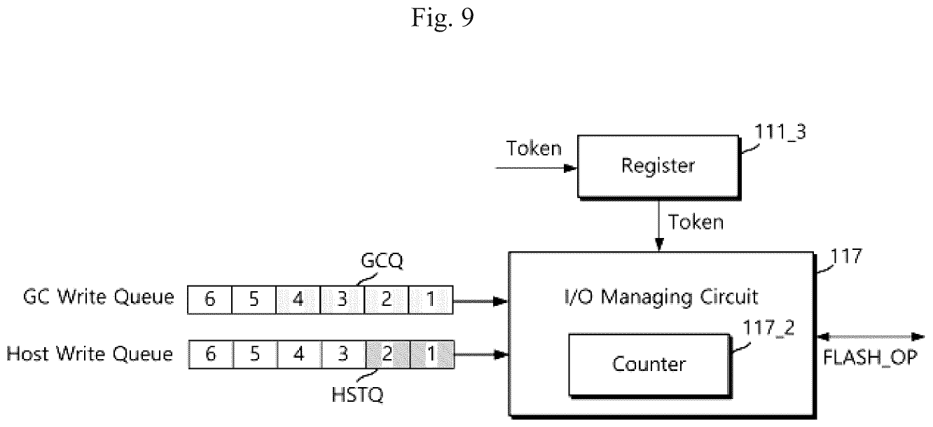

FIG. 9 is a diagram describing an operation based on tokens of an input/output managing circuit according to some example embodiments of the present disclosure. The input/output managing circuit 117 of FIG. 9 may correspond to the input/output managing circuit 117 of FIG. 8. An operation based on tokens of the input/output managing circuit 117 will be described with reference to FIGS. 8 and 9. The first write operation based on a host request and the second write operation based on garbage collection will be described with reference to FIG. 9 as an example.

The host input/output managing circuit 114 of FIG. 8 may store first internal commands for the first write operation according to the host request and/or pieces of data in a host write queue HSTQ. In some example embodiments, the host write queue HSTQ may be implemented with a buffer memory. FIG. 9 shows an example in which the host write queue HSTQ includes six cells and stores first internal commands in two cells among the six cells. However, the host write queue HSTQ may include cells, the number of which is more than the number of cells of FIG. 8.

The garbage collection circuit 111 may store pieces of data and/or second internal commands for the second write operation for performing garbage collection in a garbage collection (GC) write queue GCQ. In some example embodiments, the GC write queue GCQ may be implemented with a buffer memory. FIG. 9 shows an example in which the GC write queue GCQ includes six cells and stores second internal commands in four cells among the six cells. However, the GC write queue GCQ may include cells, the number of which is more than the number of cells of FIG. 8.

The input/output managing circuit 117 may convert internal commands stored in the host write queue HSTQ and the GC write queue GCQ into the form FLASH_OP appropriate for the write operation of the memory device 120 of FIG. 1 based on tokens and may then write or read data in or from the memory device 120.

In some example embodiments, whenever the input/output managing circuit 117 transmits the first internal commands of the host write queue HSTQ to the memory device 120 of FIG. 1 or transmits the second internal commands of the GC write queue GCQ to the memory device 120 of FIG. 1, the input/output managing circuit 117 may transmit a notification signal to an internal counter 117_2. Alternatively, whenever the size of write data according to the transmission of the first internal command and/or the second internal command reaches a desired (and/or alternatively preset) size, the input/output managing circuit 117 may transmit the notification signal indicating the transmission of each internal command to the counter 117_2.

Unlike the example illustrated in FIG. 9, the counter 117_2 may be implemented outside the input/output managing circuit 117.

The counter 117_2 may set a token stored in a register 111_3 to an initial count value. For example, the processor 112 of FIG. 5 may store information about the number of tokens generated by the garbage collection circuit 111 in the register 111_3. The processor 112 may transmit the tokens stored in the register 111_3 to the counter 117_2 of the input/output managing circuit 117. For example, the processor 112 may provide the number of tokens to the counter 117_2 of the input/output managing circuit 117.

In some example embodiments, whenever the counter 117_2 receives the notification signal from the input/output managing circuit 117, the counter 117_2 may decrease a count value from the initial count value one by one. Alternatively, whenever the counter 117_2 receives the notification signal from the input/output managing circuit 117, the counter 117_2 may increase a count value from “0”, and the count value may be compared with the number of tokens.

In some example embodiments, when the count value of the counter 117_2 reaches “0”, the input/output managing circuit 117 may transmit the notification signal to the garbage collection circuit 111. For example, when a count value based on a secondary token reaches “0”, the input/output managing circuit 117 may transmit the notification signal to the garbage collection circuit 111. The garbage collection circuit 111 may receive the notification signal and may generate secondary tokens of a next group.

Based on tokens, the input/output managing circuit 117 according to some example embodiments of the present disclosure may transmit the first internal commands of the host write queue HSTQ to the memory device 120 of FIG. 1 or may transmit the second internal commands of the GC write queue GCQ to the memory device 120 of FIG. 1.

For example, the input/output managing circuit 117 may transmit the first internal commands of the host write queue HSTQ to the memory device 120 of FIG. 1 based on the (2-1)-th tokens or may transmit the second internal command of the GC write queue GCQ to the memory device 120 of FIG. 1 based on the (2-2)-th tokens. The input/output managing circuit 117 may transmit first internal commands, the number of which corresponds to the number of (2-1)-th tokens and second internal commands, the number of which corresponds to the number of (2-2)-th tokens, to the memory device 120 of FIG. 1.

In some example embodiments, the input/output managing circuit 117 may transmit one of the first internal command of the host write queue HSTQ based on the (2-1)-th tokens and the second internal command of the GC write queue GCQ based on the (2-2)-th tokens and may then transmit the other thereof. For example, the input/output managing circuit 117 may transmit the first internal commands to the memory device 120 of FIG. 1 based on the (2-1)-th tokens and may then transmit the second internal commands to the memory device 120 of FIG. 1 based on the (2-2)-th tokens.

As described with reference to FIG. 2, all the groups constituting the secondary tokens may include secondary tokens corresponding to the first write operation and secondary tokens corresponding to the second write operation. For example, each group includes both the (2-1)-th tokens and the (2-2)-th tokens. Accordingly, the input/output managing circuit 117 may perform the first write operation and the second write operation with the uniform quality.

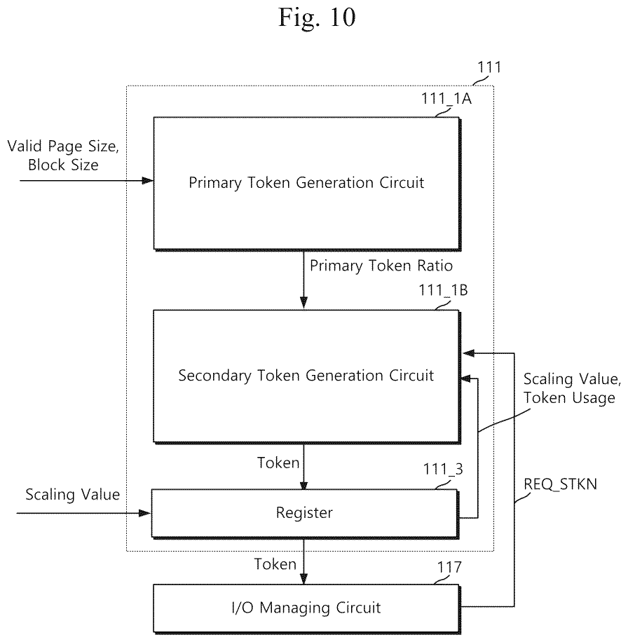

FIG. 10 is a diagram describing a configuration of a garbage collection circuit according to some example embodiments of the present disclosure. The garbage collection circuit 111 of FIG. 10 may correspond to the garbage collection circuit 111 of FIG. 5.

Functions and operations of the components of FIG. 10 may be accomplished by functions and operations of components different from the components of FIG. 8 depending on various implementations of the present disclosure. Accordingly, the components of FIG. 10 and messages and/or pieces of data which are transmitted between the components may be implemented by a method different from that of FIG. 10.

Referring to FIG. 10, the garbage collection circuit 111 according to some example embodiments of the present disclosure may include a primary token generation circuit 111_1A, a secondary token generation circuit 111_1B, and the register 111_3. Unlike FIG. 10, the register 111_3 may be implemented outside the garbage collection circuit 111.

The primary token generation circuit 111_1A may be provided with a valid page size of a victim block and a block size from the processor 112 of FIG. 5. In some example embodiments, the valid page size may refer to the number of valid pages. The block size of the victim block may be equal to the block size of the destination block.

In some example embodiments, the primary token generation circuit 111_1A may generate primary tokens for the first write operation and primary tokens for the second write operation to be proportional to the number of residual pages other than valid pages in the victim block and the number of valid pages in the victim block, respectively. The primary token generation circuit 111_1A may transmit the primary token ratio being a ratio of the primary tokens for the first write operation and the primary tokens for the second write operation to the secondary token generation circuit 111_1B.

In some example embodiments, the secondary token generation circuit 111_1B may generate a secondary token based on a secondary token generation request REQ_STKN of the input/output managing circuit 117. The input/output managing circuit 117 may determine the number of secondary tokens such that the primary residual token ratio (e.g., the ratio of the residual amount of primary tokens allocated to the first write operation and the residual amount of primary tokens allocated to the second write operation) is the same or substantially the same as the secondary token ratio.

In some example embodiments, the secondary token generation circuit 111_1B may use a token consumption amount stored in the register 111_3 to calculate the primary residual token ratio. The secondary token generation circuit 111_1B may use a scaling value stored in the register 111_3 to determine the number of secondary tokens. The scaling value may refer to the desired (and/or alternatively preset) number of secondary tokens allocated to the first write operation or the second write operation for each group. The secondary token generation circuit 111_1B may determine the number of secondary tokens (e.g., a count number of secondary tokens), based on Equation 1 described with reference to FIG. 2.

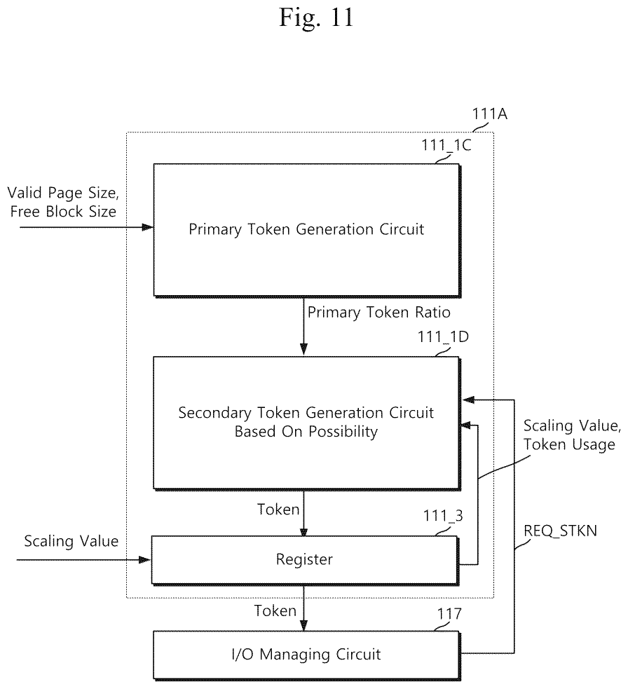

FIG. 11 is a diagram describing a configuration of a garbage collection circuit according to some example embodiments of the present disclosure. A garbage collection circuit 111A of FIG. 11 may correspond to the garbage collection circuit 111 of FIG. 5.

Functions and operations of the components of FIG. 11 may be accomplished by functions and operations of components different from the components of FIG. 8 depending on various implementations of the present disclosure. Accordingly, the components of FIG. 11 and messages and/or pieces of data which are transmitted between the components may be implemented by a method different from that of FIG. 11.

The garbage collection circuit 111A of FIG. 11 will be described with reference to FIG. 11. The description which is the same as or similar to the description given with reference to FIG. 10 will be omitted to avoid redundancy.

Unlike the garbage collection circuit 111 of FIG. 10, a secondary token generation circuit 111_1B of the garbage collection circuit 111A of FIG. 11 may generate secondary tokens based on probability. For example, as described with reference to FIG. 2, when the number of secondary tokens of each group determined based on Equation 1 above and the scaling value is a decimal, the garbage collection circuit 111A may determine the number of secondary tokens based on the probability corresponding to numbers of decimal places.

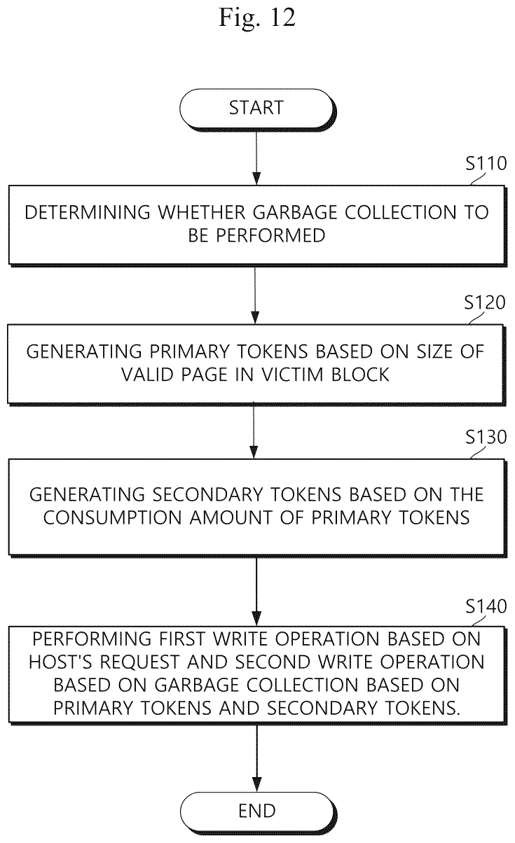

FIG. 12 is a flowchart describing an operating method of a storage device according to some example embodiments of the present disclosure. The operating method of FIG. 12 may be performed by the storage device 100 of FIG. 1.

Referring to FIG. 12, in operation S110, the memory controller 110 of FIG. 1 may determine whether the execution of garbage collection is to be performed. The memory controller 110 may determine whether to perform garbage collection based on various references or schemes that should be within the level of ordinary skill.

In operation S120, the memory controller 110 may generate primary tokens based on the size of a valid page(s) in a victim block.

FIG. 13 is a diagram describing an operation in which the memory controller 110 generates primary tokens, as an example. A victim block before the execution of garbage collection and a destination block experiencing garbage collection are illustrated in FIG. 13 as an example.

Referring to FIG. 13, the victim block may include valid pages VP1, VP2, and VP3. The valid pages VP1, VP2, and VP3 may be spaced apart from each other as illustrated in FIG. 13; alternatively, unlike FIG. 13, some valid pages in the victim block may be placed adjacent to each other. The valid pages VP1, VP2, and VP3 may be written in the destination block targeted for garbage collection so as to be adjacent to each other. Unlike FIG. 13, some valid pages may be placed in the destination block so as to be spaced apart from each other.

The memory controller 110 may determine the primary token ratio based on the size PT1 of valid pages of the victim block in the destination block and the size PT2 of residual pages of the destination block other than the valid pages and may generate primary tokens based on the primary token ratio.

The first write operation according to the host request may be performed in the residual pages of the destination block based on the size PT1 of the destination block, and the second write operation of garbage collection may be performed in the valid pages VP1, VP2, and VP3 of the destination block based on the size PT2 of the destination block.

Returning to FIG. 12, in operation S130, the memory controller 110 may generate secondary tokens based on a consumption amount of the primary tokens.

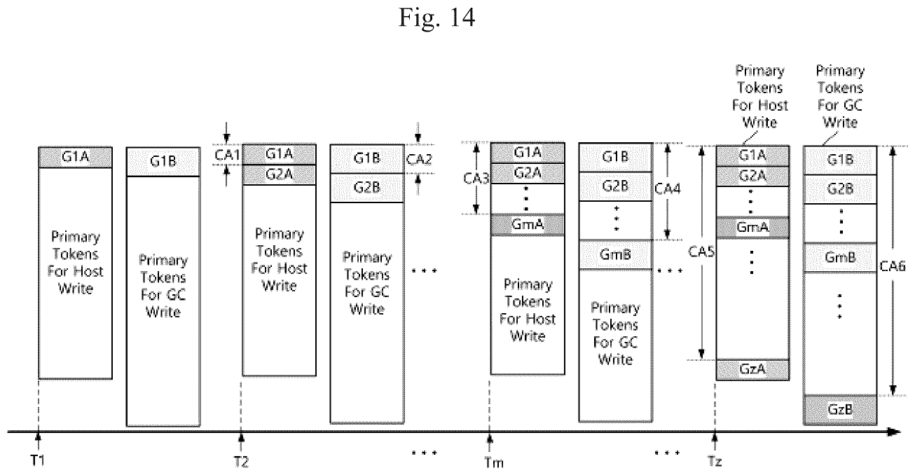

FIG. 14 is a diagram describing an operation in which the memory controller 110 generates secondary tokens, as an example. FIG. 14 shows how primary tokens change based on secondary tokens generated by the memory controller 110 at a plurality of time points T1, T2, . . . , Tm, . . . , Tz, as an example.

Referring to FIG. 14, at T1, the memory controller 110 may generate secondary tokens G1A and G1B of a first group, based on the primary token ratio. For example, the memory controller 110 may generate the (2-1)-th tokens G1A and the (2-2)-th tokens G1B of the first group.

At T2, the memory controller 110 may generate the secondary (2-1)-th tokens G2A and the (2-2)-th tokens G2B of a second group. The memory controller 110 may generate the (2-1)-th tokens G2A and the (2-2)-th tokens G2B of a second group, based on a consumption amount CA1 of the (1-1)-th tokens consumed before T2 and a consumption amount CA2 of the (1-2)-th tokens consumed before T2.

Likewise, at Tm, the memory controller 110 may generate the secondary (m-1)-th tokens GmA (m being a natural number of 3 or more) and the (m-2)-th tokens GmB of an m-th group. The memory controller 110 may generate the (m-1)-th tokens GmA and the (m-2)-th tokens GmB of the m-th group, based on a consumption amount CA3 of the (1-1)-th tokens consumed before Tm and a consumption amount CA4 of the (1-2)-th tokens consumed before Tm.

At Tz, the memory controller 110 may generate secondary tokens GzA and GzB of the last group. The memory controller 110 may generate the residual primary tokens except for a consumption amount CA5 of the (1-1)-th tokens consumed before Tz and the residual primary tokens except for a consumption amount CA6 of the (1-2)-th tokens consumed before Tz as the secondary tokens GzA and GzB of the last group, respectively.

Returning to FIG. 12, in operation S140, the memory controller 110 may perform the first write operation based on the host request and the second write operation based on garbage collection, based on the primary tokens and the secondary tokens.

For example, after the memory controller 110 generates the (2-1)-th tokens G1A and the (2-2)-th tokens G1B of the first group of FIG. 14, the memory controller 110 may perform the first write operation and the second write operation based on the (2-1)-th tokens G1A and the (2-2)-th tokens G1B of the first group. Likewise, the memory controller 110 may perform the first write operation and the second write operation based on the (m-1)-th tokens GmA and the (m-2)-th tokens GmB of the m-th group and may perform the first write operation and the second write operation based on the secondary tokens GzA and GzB of the last group. Whenever the memory controller 110 performs the first write operation and the second write operation, the memory controller 110 may use both the primary token and the secondary token.

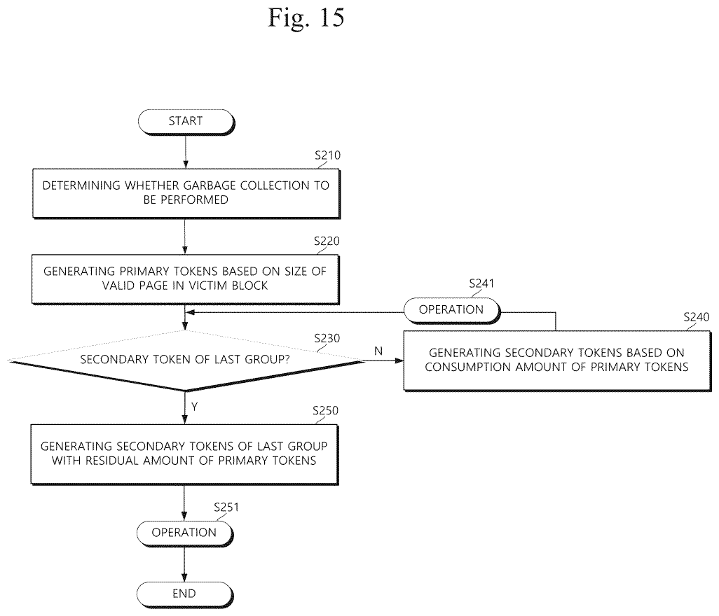

FIG. 15 is a flowchart describing an operating method of a storage device according to some example embodiments of the present disclosure. The operating method of FIG. 15 may be performed by the storage device 100 of FIG. 1. The description which is the same as or similar to the description given with reference to FIG. 12 will be omitted to avoid redundancy.

Referring to FIG. 15, in operation S210, the memory controller 110 of FIG. 1 may determine whether the execution of garbage collection is to be performed.

In operation S220, the memory controller 110 may generate primary tokens based on the size of a valid page(s) in victim block. For example, the memory controller 110 may generate primary tokens as described with reference to FIG. 13.

In operation S230, the memory controller 110 may start the generation of secondary tokens, and may check whether secondary tokens to be generated are secondary tokens of the last group.

For example, when secondary tokens to be generated are not secondary tokens of the last group as indicated by N at S230, in operation S240, the memory controller 110 may generate secondary tokens of each group based on a consumption amount of primary tokens. For example, the memory controller 110 may generate secondary tokens as described with reference to FIG. 14.

In operation S241, the memory controller 110 may perform the first write operation and the second write operation based on the secondary tokens of each group thus generated.

Returning to operation S230, the memory controller 110 checks whether secondary tokens to be generated are secondary tokens of the last group. When secondary tokens to be generated are secondary tokens of the last group as indicated by Y at S230, in operation S250, the memory controller 110 generates secondary tokens of the last group with residual tokens among the primary tokens.

In operation S251, the memory controller 110 may perform the first write operation and the second write operation based on the secondary tokens of the last group thus generated.

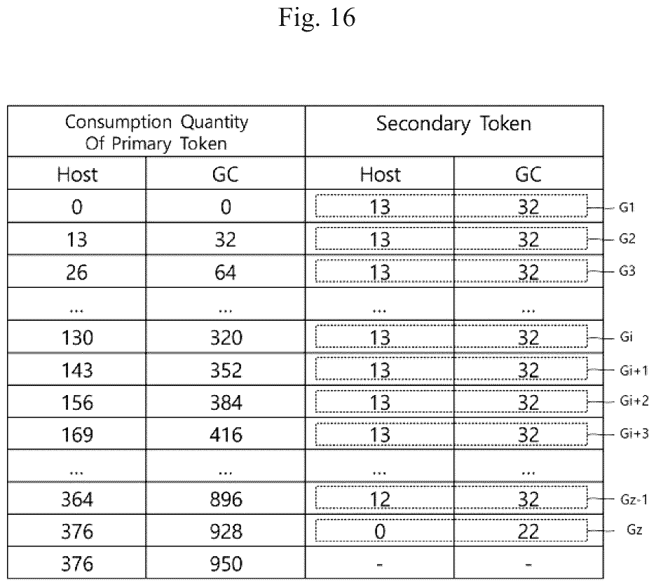

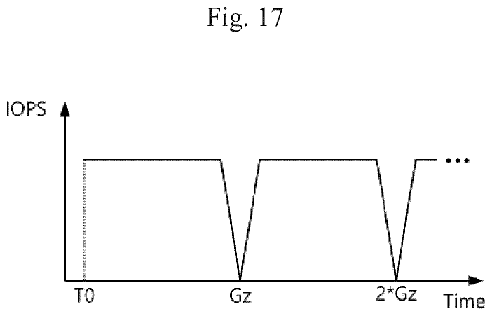

FIG. 16 is a diagram describing a comparative example of an operation method in which a storage device may generate a primary token and a secondary token. FIG. 17 is a diagram describing a change in performance of a storage device according to the comparative example.

FIG. 16 will be described under the assumption that the primary token ratio being a ratio of primary tokens for the first write operation and primary tokens for the second write operation among the primary tokens is determined as 376:950 and the number of secondary tokens (e.g., (2-1)-th tokens) allocated to the first write operation for each group is in advance set to the scaling value of 32. Accordingly, a storage device may normalize pages of a victim block to 1,326 (=376+950) which is based on 376:950 being the primary token ratio and may perform the first write operation and the second write operation. For example, the storage device may perform write operations of pages corresponding to 1/1,326 from among all the pages of a relevant block, based on one primary token.

FIG. 16 is described under the assumption that the storage device generates secondary tokens so as to be classified into the plurality of groups G1 to Gz. FIG. 16 shows an example in which the number of secondary tokens (e.g., (2-2)-th tokens) for the second write operation of the remaining groups G1 to Gz-1 other than the last group Gz is in advance set to the scaling value of 32.

Referring to FIG. 16, the storage device may generate the (2-1)-th tokens such that the number of secondary tokens (e.g., (2-1)-th tokens) for the first write operation are maintained as uniform as possible. For example, the storage device may generate the (2-1)-th tokens based on the primary token ratio and the scaling value. For example, the storage device may generate the (2-1)-th tokens of some groups G1 to Gz-2 based on Equation 2 below.

$$376 : 950 = the number of ( 2 - 1 ) - th tokens of group : scaling value \qquad 〈 Equation 2 〉$$

Accordingly, the number of (2-1)-th tokens of some groups G1 to Gz-2 may be equal to 13 obtained by rounding up 12.67.

In some example embodiments, in the last group Gz, because all the (1-1)-th tokens are already consumed, the storage device may not generate the (2-1)-th tokens. Accordingly, as illustrated in FIG. 16, the performance of the storage device based on the first write operation may greatly fluctuate whenever all the primary tokens are consumed.

In contrast, when the number of (2-1)-th tokens of some groups G1 to Gz-2 is equal to 12 obtained by performing truncation for 12.67, the (2-2)-th tokens for garbage collection may be incapable of being generated in some groups including the last group. Accordingly, the performance of garbage collection of the storage device may greatly fluctuate.

For example, the storage device according to the comparative example described with reference to FIG. 16 may experience great change in performance repeatedly every period by which the primary tokens are generated, as shown in FIG. 17 for example. This may mean that the quality of service of the storage device is not uniform.

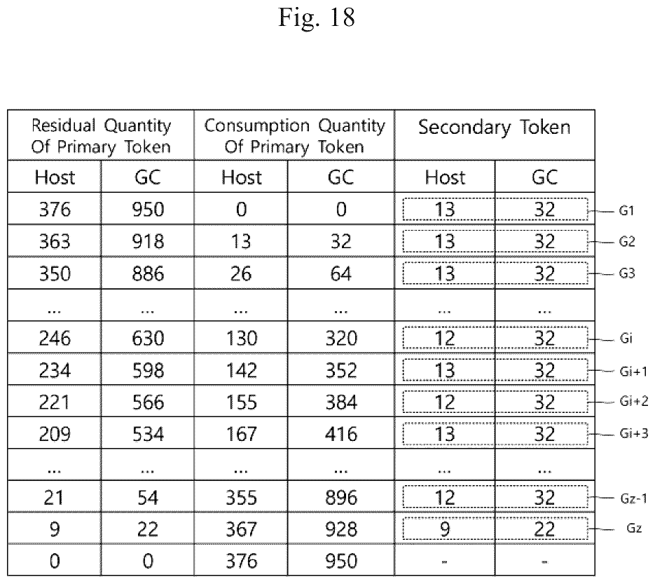

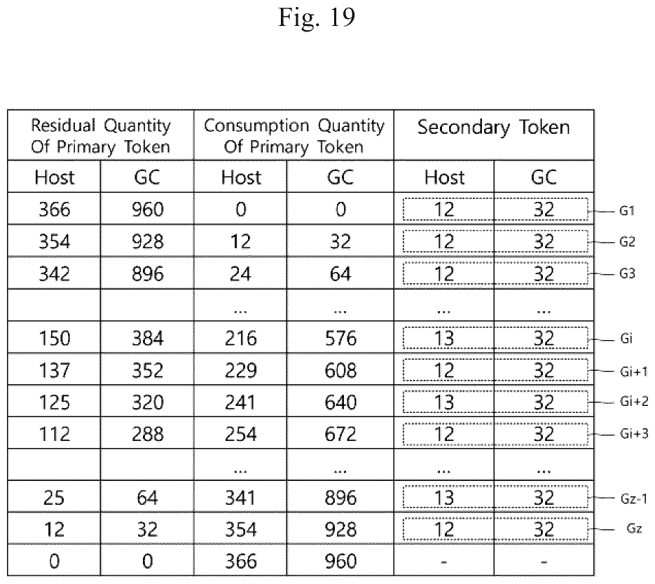

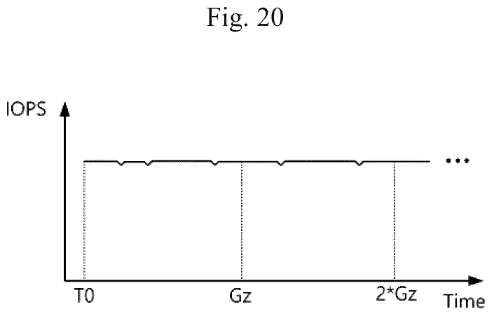

FIGS. 18 and 19 are diagrams describing methods in which a storage device according to some example embodiments of the present disclosure generates a primary token and a secondary token. FIG. 20 is a diagram describing a change in performance of a storage device according to some example embodiments of the present disclosure. The methods of FIGS. 18 and 19 may be performed by the storage device 100 of FIG. 1.

In some example embodiments, FIG. 18 will be described under the assumption that the primary token ratio and the scaling value are the same as those of FIG. 16.

FIG. 18 will be described under the assumption that the storage device 100 generates secondary tokens so as to be classified into the plurality of groups G1 to Gz. FIG. 18 shows an example in which the number of secondary tokens (e.g., (2-2)-th tokens) for the second write operation of the remaining groups G1 to Gz-1 other than the last group Gz is in advance set to the scaling value of 32.

Referring to FIG. 18, like the number of secondary tokens (e.g., (2-1)-th tokens) for the first write operation described with reference to FIG. 2, the storage device 100 may generate the (2-1)-th tokens based on a consumption amount of the primary tokens. For example, the storage device may generate the (2-1)-th tokens of the remaining groups G1 to Gz-1 other than the last group Gz based on Equation 1 above and the scaling value.

Referring to FIG. 18, the storage device 100 may generate the (2-1)-th tokens in the remaining groups G1 to Gz-1 other than the last group Gz such that the numbers of (2-1)-th tokens are almost similar to each other. Also, even in the last group Gz, the storage device 100 may generate the secondary (2-1)-th tokens based on the residual amount of the primary tokens. Accordingly, as illustrated in FIG. 20, the performance of the storage device based on the first write operation may be maintained uniformly regardless of a period by which the primary tokens are generated.

FIG. 19 shows some example embodiments under the assumption that the same scaling value as described with reference to FIG. 18 is used but the primary token ratio is differently set.

FIG. 19 will be described under the assumption that the storage device 100 generates secondary tokens so as to be classified into the plurality of groups G1 to Gz. FIG. 19 shows an example in which the number of secondary tokens (e.g., (2-2)-th tokens) for the second write operation of the remaining groups G1 to Gz-1 other than the last group Gz is in advance set to the scaling value of 32.

In some example embodiments, FIG. 19 will be described under the assumption that the primary token ratio being a ratio of primary tokens for the first write operation and primary tokens for the second write operation among the primary tokens is determined to be 366:960 unlike the embodiment described with reference to FIG. 18 and the number of secondary tokens (e.g., (2-1)-th tokens) allocated to the first write operation for each group is in advance set to the scaling value of 32. For example, unlike the embodiment described with reference to FIG. 18, the storage device 100 may determine the number of (1-2)-th tokens as a multiple of the scaling value. The storage device 100 may determine the number of (1-1)-th tokens based on the number of (1-2)-th tokens and the size of valid pages of the victim block. FIG. 19 is described under the assumption that the number (or size) of valid pages corresponds to 366 and the number of remaining pages of the victim block other than the valid pages corresponds to 960.

Referring to FIG. 19, the storage device 100 may generate the (2-1)-th tokens in the remaining groups G1 to Gz-1 other than the last group Gz such that the numbers of (2-1)-th tokens are almost similar to each other. Also, even in the last group Gz, the storage device 100 may generate the (2-1)-th tokens based on the residual amount of the primary tokens. Because the number of (1-2)-th tokens is determined as a multiple of the scaling value, the number of (2-2)-th tokens of all the groups G1 to Gz is equal to the scaling value. Accordingly, as illustrated in FIG. 20, the performance of the storage device based on the first write operation may be maintained uniformly regardless of a period by which the primary tokens are generated.

A storage device according to the present disclosure may maintain the quality of execution of a background operation and a foreground operation uniformly. Accordingly, the quality of service of the storage device may be improved. For example, a storage device capable of maintaining and/or improving the quality and/or uniformity of execution of a background operation and a foreground operation may be provided.

One or more of the elements disclosed above may include or be implemented in processing circuitry such as hardware including logic circuits; a hardware/software combination such as a processor executing software; or a combination thereof. For example, the processing circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

While the present disclosure has been described with reference to some example embodiments thereof, it will be apparent to those of ordinary skill in the art that various changes and modifications may be made thereto without departing from the spirit and scope of the present disclosure as set forth in the following claims.

What is claimed is:

1. A storage device comprising:
a memory device including a plurality of nonvolatile memory blocks; and
a memory controller configured to control the memory device,
wherein the memory controller is configured to
perform a first write operation based on a request of a host and a second write operation based on garbage collection on the memory device, based on primary tokens and secondary tokens,
generate the primary tokens based on a size of a valid page of a victim block from among the plurality of nonvolatile memory blocks, and
generate the secondary tokens based on a consumption amount of the primary tokens.

2. The storage device of claim 1, wherein a number of the primary tokens is equal to a total number of the secondary tokens.

3. The storage device of claim 2, wherein the memory controller is configured to generate the primary tokens and the secondary tokens so that
a number of primary tokens allocated to the first write operation from among the primary tokens is equal to a total number of secondary tokens allocated to the first write operation from among the secondary tokens, and
a number of primary tokens allocated to the second write operation from among the primary tokens is equal to a total number of secondary tokens allocated to the second write operation from among the secondary tokens.

4. The storage device of claim 1, wherein the memory controller is configured to
generate the secondary tokens as classified into a plurality of groups,
consume secondary tokens belonging to a first group among the plurality of groups from among the secondary tokens based on execution of the first write operation and the second write operation, and
generate secondary tokens belonging to a second group among the plurality of groups from among the secondary tokens based on consumption of the secondary tokens of the first group,
wherein a total number of the secondary tokens classified into the plurality of groups is equal to a number of the primary tokens.

5. The storage device of claim 4, wherein the memory controller is configured to generate the secondary tokens such that a ratio of a number of secondary tokens allocated to the first write operation from among the secondary tokens and a number of secondary tokens allocated to the second write operation from among the secondary tokens is based on a ratio of a residual amount of primary tokens allocated to the first write operation from among the primary tokens and a residual amount of primary tokens allocated to the second write operation from among the primary tokens.

6. The storage device of claim 5, wherein the memory controller is configured to fix the number of the secondary tokens allocated to the second write operation for each of the plurality of groups and generate the secondary tokens allocated to the first write operation.

7. The storage device of claim 5, wherein the memory controller is configured to stochastically generate the secondary tokens corresponding to the first write operation, based on a ratio of the secondary tokens corresponding to the first write operation and the secondary tokens corresponding to the second write operation.

8. The storage device of claim 1, wherein the memory controller is configured to
generate the secondary tokens as classified into a plurality of groups, and
consume the secondary tokens for each of the plurality of groups based on execution of the first write operation and the second write operation, and
wherein a total number of the secondary tokens classified into the plurality of groups is equal to a number of the primary tokens.

9. The storage device of claim 1, wherein
the secondary tokens are classified into a plurality of groups, and
each of the plurality of groups includes secondary tokens corresponding to the first write operation from among the secondary tokens and secondary tokens corresponding to the second write operation from among the secondary tokens.

10. The storage device of claim 9, wherein, for remaining groups among the plurality of groups other than one group, the memory controller is configured to generate the secondary tokens corresponding to the first write operation to be identical in number, or generate the secondary tokens corresponding to the second write operation to be identical in number.

11. A storage device comprising:
a memory device including a plurality of nonvolatile memory blocks; and
a memory controller configured to control the memory device,
wherein the memory controller includes
a token generation circuit configured to generate primary tokens and secondary tokens, and
an input/output managing circuit configured to transmit, to the memory device, first internal commands for a first write operation based on a request of a host and second internal commands for performing a second write operation based on garbage collection, based on the secondary tokens, and
wherein the token generation circuit is configured to
generate the primary tokens based on a size of a valid page of a victim block from among the plurality of nonvolatile memory blocks, and
generate the secondary tokens based on a consumption amount of the primary tokens.

12. The storage device of claim 11, wherein the token generation circuit includes:
a primary token generation circuit configured to generate the primary tokens; and
a secondary token generation circuit configured to generate the secondary tokens,
wherein the secondary token generation circuit is configured to receive a primary token ratio from the primary token generation circuit, the primary token ratio being a ratio of primary tokens corresponding to the first write operation from among the primary tokens and primary tokens corresponding to the second write operation from among the primary tokens.

13. The storage device of claim 12, wherein the primary token generation circuit is configured to generate the primary tokens corresponding to the first write operation and the primary tokens corresponding to the second write operation based on the size of the valid page of the victim block and a size of a destination block from among the plurality of nonvolatile memory blocks.

14. The storage device of claim 12, wherein the secondary token generation circuit is configured to receive a number of the primary tokens corresponding to the first write operation, a number of the primary tokens corresponding to the second write operation, a consumption amount of the primary tokens corresponding to the first write operation, and a consumption amount of the primary tokens corresponding to the second write operation.

15. The storage device of claim 14, wherein the secondary token generation circuit is configured to generate the secondary tokens such that a ratio of secondary tokens corresponding to the first write operation from among the secondary tokens and secondary tokens corresponding to the second write operation from among the secondary tokens is based on a ratio of the consumption amount of the primary tokens corresponding to the first write operation and the consumption amount of the primary tokens corresponding to the second write operation.

16. The storage device of claim 12, wherein the primary token generation circuit is configured to generate the primary tokens during a first period and the secondary token generation circuit is configured to generate the secondary tokens during a second period, and the first period is longer than the second period.

17. An operating method of a storage device, the storage device including a memory controller and a memory device, the operating method comprising:
determining, at the memory controller, to execute garbage collection on the memory device;
generating, at the memory controller, primary tokens based on a size of a valid page of a victim block of the memory device on which the garbage collection is performed;
generating, at the memory controller, secondary tokens based on a consumption amount of the primary tokens; and
performing, at the memory controller, a first write operation based on a request of a host and a second write operation based on the garbage collection, based on the primary tokens and the secondary tokens.

18. The operating method of claim 17, wherein said generating the secondary tokens comprises generating secondary tokens belonging to a first group from among the secondary tokens, and said performing the first write operation and the second write operation is based on the secondary tokens of the first group, and
wherein the operating method further comprises generating, at the memory controller, secondary tokens belonging to a second group from among the secondary tokens, based on consumption of the secondary tokens of the first group.

19. The operating method of claim 18, wherein said generating the secondary tokens belonging to the first group and said generating the secondary tokens belonging to the second group comprises generating the secondary tokens so that a ratio of secondary tokens corresponding to the first write operation from among the secondary tokens and secondary tokens corresponding to the second write operation from among the secondary tokens is based on a ratio of a consumption amount of primary tokens corresponding to the first write operation from among the primary tokens and a consumption amount of primary tokens corresponding to the second write operation from among the primary tokens.

20. The operating method of claim 19, wherein said generating the secondary tokens of each of the first and second groups comprises generating, at the memory controller, the secondary tokens corresponding to the first write operation to be identical in number, or generating the secondary tokens corresponding to the second write operation to be identical in number.
